(19) United States
(12) Patent Application Publication
(10) Pub. No.: US 2022/0337123 A1
(43) Pub. Date: Oct. 20, 2022

(54) SMART ASSEMBLY AND METHOD FOR UNLIMITED POWER GENERATION USING SERIES OF ROTATABLE MEMBERS

(71) Applicants: Muhammad Reazul HAQUE, Cyberjaya (MY); Fahmid AL-FARID, Cyberjaya (MY); Sayed Nafiz HAIDER, Cyberjaya (MY); Md Mahedi HASSAN, Cyberjaya (MY); Manjur ELAHI, Cyberjaya (MY); Zulfadzli YUSOFF, Sepang (MY)

(72) Inventors: Muhammad Reazul HAQUE, Cyberjaya (MY); Fahmid AL-FARID, Cyberjaya (MY); Sayed Nafiz HAIDER, Cyberjaya (MY); Md Mahedi HASSAN, Cyberjaya (MY); Manjur ELAHI, Cyberjaya (MY); Zulfadzli YUSOFF, Sepang (MY)

(21) Appl. No.: 17/640,217

(22) PCT Filed: Sep. 3, 2020
(86) PCT No.: PCT/MY2020/050081

§ 371 Date: Mar. 3, 2022

(30) Foreign Application Priority Data
Sep. 3, 2019 (MY) PI 2019005063

(51) Int. Cl. H02K 7/18

(52) U.S. Cl. CPC H02K 7/1861; B60L 50/20

(57) ABSTRACT

The present invention discloses an assembly and method for power generation. The assembly comprises a first rotatable member (100), a second rotatable member (200) driven to move by the first rotatable member (100) at which the second rotatable member (200) is in contact with, a third rotatable member (300) driven to move about a rotating axis by the second rotatable member (200) thereof, a rotatable disk (400) mounted to the third rotatable member (300) driven to move correspondingly about the said rotating axis by the third rotatable member (300) thereof, and an electromechanical energy converter (500) having a rotatable unit (501) coupled to the rotatable disk (400) configured for generating electrical energy.

### FIELD OF THE INVENTION

The present invention relates generally to electrical power generation. More particularly, the present invention relates to an improved assembly and method for generating electrical power by way of a series of rotatable members connected thereof.

### BACKGROUND OF THE INVENTION

Global electricity demand which is a key pillar for human wellbeing, economic development and poverty alleviation, has increased by averagely 4% every year, or 900 TWh per year, growing nearly twice as fast as the overall demand for energy. This rate was also the fastest increase since 2010, when the global economy recovered from the financial crisis. Together, renewables and nuclear power met a majority of the increase in power demand. Still, generation from coal- and gas-fired power plants also rose considerably to meet higher electricity demand, driving up carbon dioxide (CO₂) emissions from the sector by 2.5%. Emissions from power generation reached about 13 Gt, or 38% of total energy-related CO₂ emissions last year.

However, the current energy systems have various environmental impacts. Current electricity generation using oil, gas, coal, solar, wind and nuclear power produces CO₂ and other greenhouse gases which are the fundamental driver of global climate change. A significant and concerted transition in energy sources is therefore required to meet our global climate targets and avoid dangerous climate change. Furthermore, another pressing issue is that oil, gas and coal reserves are being depleted much faster than new ones are being made. Energy conversion from solar and wind power are highly dependent upon the presence of sun and wind.

Several alternative approaches have been proposed to generate electricity. For example, one method as described in U.S. Pat. No. 7,253,534 B2 (hereinafter “the '534 patent”) discloses a device for converting human power to electrical power. According to '534 patent, the device comprises a plurality of gear wheels interconnected with a plurality of interconnection means, a first axle disposed through an opening in a center of a first gear wheel of the plurality of gear wheels; a first pedal mounted on a first pedal arm and a second pedal mounted on a second pedal arm, each pedal arm mounted on opposing ends of the first axle, a second gear wheel of the plurality of gear wheels interconnected to the first gear wheel with a first interconnection means of the plurality of interconnection means, an alternator interconnected to one of the gear wheels of the plurality of gear wheels, a battery and an inverter.

Taking into consideration of the above, there still exists a need for an improved assembly and method for power generation using a series of rotatable members thereby overcoming the problems and shortcomings of the prior art.

### SUMMARY OF THE INVENTION

The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

Accordingly, the present invention provides an assembly for power generation comprising a series of rotatable members.

The assembly of the present invention may be characterized by the series of rotatable members comprising a first rotatable member, a second rotatable member driven to move by the first rotatable member at which the second rotatable member is in contact with, a third rotatable member driven to move about a rotating axis by the second rotatable member thereof, a rotatable disk mounted to the third rotatable member driven to move correspondingly about the said rotating axis by the third rotatable member thereof, and an electromechanical energy converter having a rotatable unit coupled to the rotatable disk configured for generating electrical energy.

Preferably, the rotatable disk includes a sprocket deployed in a side-by-side manner with the third rotatable member thereof.

Preferably, the rotatable disk is connected to the rotatable unit of the electromechanical energy converter by a chain or belt that extends around the rotatable disk and the said rotatable unit so as to drive the rotatably unit thereof.

Preferably, the rotatable disk is in contact with the rotatable unit of the electromechanical energy converter directly to drive the rotatable unit thereof.

Preferably, the first rotatable member comprises a first rubber element mounted to the first rotatable member thereof.

Preferably, the second rotatable member is in contact with the third rotatable member to drive the third rotatable member thereof.

Preferably, the second rotatable member comprises a second rubber element mounted to the second rotatable member thereof.

Preferably, the third rotatable member comprises a third rubber element mounted to the third rotatable member thereof.

Preferably, the second rotatable member has a diameter relatively smaller than that of the first rotatable member and relatively larger than that of the third rotatable member.

Preferably, the first rotatable member is configured to initiate rotation of the second rotatable member by way of rotating itself.

Preferably, the assembly comprises a chassis frame for supporting the first rotatable member, the second rotatable member, the third rotatable member, the rotatable disk and the electromechanical energy converter.

In accordance with another aspect of the present invention, there is provided a method of power generation. The method may be characterized by the steps of initiating rotation of a second rotatable member by way of rotating a first rotatable member which is in contact with the second rotatable member thereof; driving, by the second rotatable member, rotation of a third rotatable member to move about a rotating axis; driving, by the third rotatable member, rotation of a rotatable disk mounted to the third rotatable member to move correspondingly about the said rotating axis; and driving, by the rotatable disk, rotation of a rotatable unit of an electromechanical energy converter for generating electrical energy.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

A more complete appreciation of the invention and many of the attendant advantages thereof will be readily as the same becomes better understood by reference to the following detailed description when considered in connection with the accompanying drawings, wherein:

FIG. 1 shows an assembly for power generation according to one embodiment of the present invention;

FIG. 2 shows an arrangement of the assembly of FIG. 1 for use with a vehicle according to one exemplary embodiment of the present invention;

FIG. 3 shows an assembly for power generation according to one alternative embodiment of the present invention;

FIG. 4 shows an arrangement of the assembly of FIG. 3 for use within a vehicle according to one alternative embodiment of the present invention;

FIG. 4a shows an arrangement of the assembly of FIG. 1 for use within a vehicle according to one alternative embodiment of the present invention;

FIG. 5 shows an assembly for power generation according to another alternative embodiment of the present invention;

FIG. 6 shows an assembly for power generation according to yet another alternative embodiment of the present invention;

FIG. 6a shows the assembly of FIG. 6 having deployed with an artificial intelligence (AI) charge controller and/or speed controller and/or cooling system controller according to yet another alternative embodiment of the present invention;

FIG. 7 shows an arrangement of the assembly of FIG. 6 with incorporation of a propeller assembly according to yet another alternative embodiment of the present invention;

FIG. 8 shows an arrangement of the assembly of FIG. 6 with incorporation of a propeller assembly according to yet another alternative embodiment of the present invention; and

FIG. 9 shows an arrangement of an assembly for power generation with an electric vehicle without a battery assembly according to yet another alternative embodiment of the present invention.

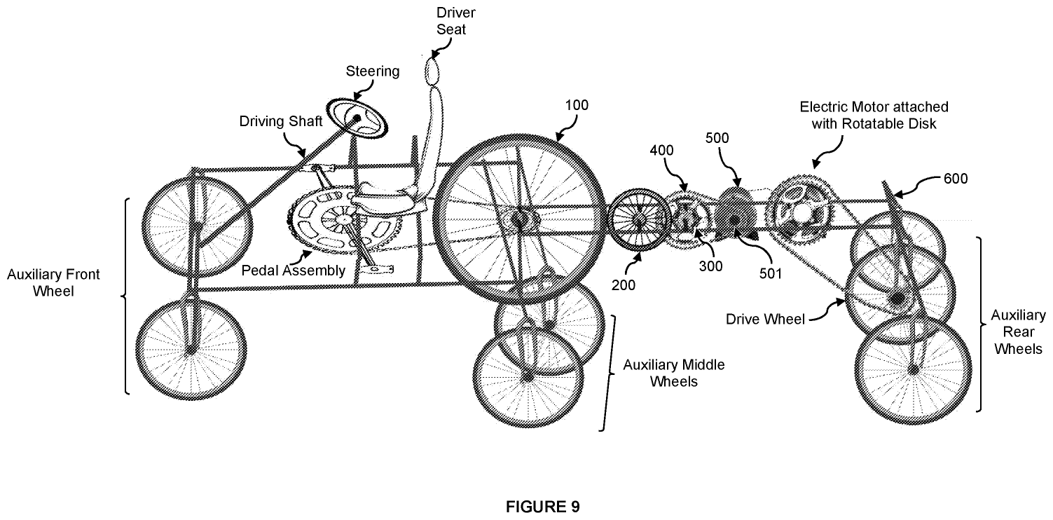

It is noted that the drawings may not be to scale. The drawings are intended to depict only typical aspects of the invention, and therefore should not be considered as limiting the scope of the invention. In the drawings, like numberings represent like elements between the drawings.

### DETAILED DESCRIPTION OF THE INVENTION

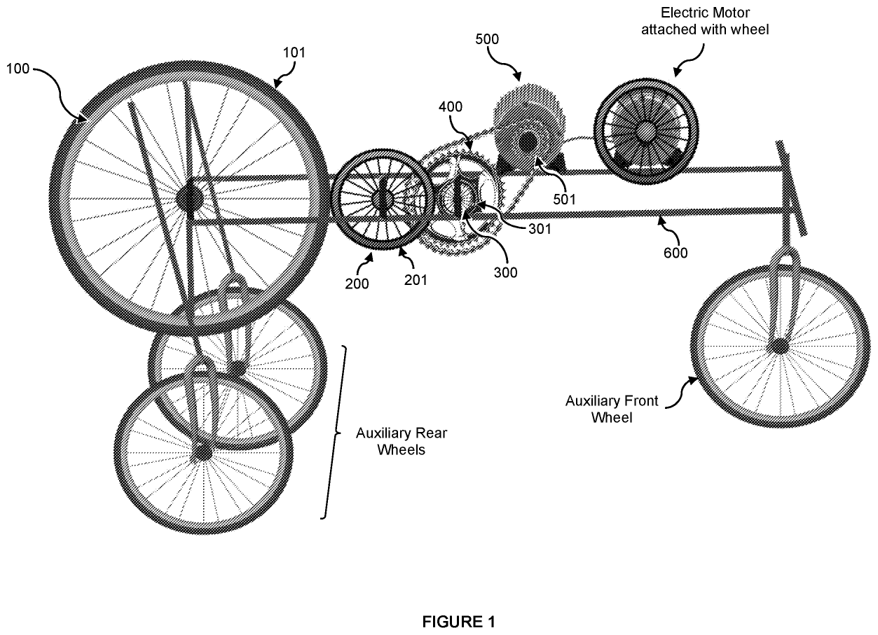

Essentially, the present invention, commercially known as “Reazul Unlimited Smart Power Electromechanical & Electromagnetic Intelligent Green Technology or RUSPEEI Green Technology or RGT”, provides an assembly employing a series of rotatable members interconnected with each other configured for power generation. Advantageously, the energy wastage of the present invention is very few compared to the existing conventional invention. According to one preferred embodiment of the present invention, the series of rotatable members of the assembly comprises a first rotatable member 100, a second rotatable member 200, a third rotatable member 300, a rotatable disk 400 and an electromechanical energy converter 500 having a rotatable unit 501. The rotatable members may be a wheel. The assembly of the present invention further comprises a chassis frame 600. The assembly of the present invention, particularly the series of rotatable members, is exemplarily shown in FIG. 1 of the accompanying drawings.

The first rotatable member 100 is preferably configured to initiate rotation of the second rotatable member 200 by way of rotating itself about an axis. The first rotatable member 100 can be rotatably driven by any drive means including drive devices. The first rotatable member 100 may also be manually rotated by hand. It is also possible for the first rotatable member 100 to be rotatably driven upon sufficient contact with a moving object or surface like roadways. It is preferred that the first rotatable member 100 is mounted to and is supported by the chassis frame 600 thereof.

The first rotatable member 100 preferably comprises a first rubber element 101 mounted to an outer periphery of the first rotatable member 100 thereof. By rubber is meant any of the natural or synthetic polymers used in the rubber and plastics industry but may be of any material which is rigid at normal temperature or other rubber-like flexible material. The first rubber element 101 provides a cushion between the first rotatable member 100 and the second rotatable member 200 and minimizing damage due to relative movement therebetween. The first rubber element 101 may be applied either as a separate rubber sleeve assembled over the outer periphery of the first rotatable member 100 or may be molded on or bonded to the first rotatable member 100 by steel pressing in a single operation.

The second rotatable member 200 is connected to the first rotatable member 100. The second rotatable member 200 is preferably driven to move by the first rotatable member 100. It is preferred that the second rotatable member 200 is in contact with the first rotatable member 100 thereof. It is preferred that the second rotatable member 200 is mounted to and is supported by the chassis frame 600 thereof. The second rotatable member 200 preferably comprises a second rubber element 201 mounted to an outer periphery of the second rotatable member 200 thereof. By rubber is meant any of the natural or synthetic polymers used in the rubber and plastics industry but may be of any material which is rigid at normal temperature or other rubber-like flexible material. The second rubber element 201 provides a cushion between the second rotatable member 200 and the first rotatable member 100 and minimizing damage due to relative movement therebetween. The second rubber element 201 may be applied either as a separate rubber sleeve assembled over the outer periphery of the second rotatable member 200 or may be molded on or bonded to the second rotatable member 200 by steel pressing in a single operation.

The third rotatable member 300 is connected to the second rotatable member 200. The third rotatable member 300 is preferably driven to move about a rotating axis by the second rotatable member 200 thereof. It is preferred that the third rotatable member 300 is in contact with the second rotatable member 200 thereof. Preferably, the third rotatable member 300 is mounted to and is supported by the chassis frame 600 thereof.

The third rotatable member 300 preferably comprises a third rubber element 301 mounted to an outer periphery of the third rotatable member 300 thereof. By rubber is meant any of the natural or synthetic polymers used in the rubber and plastics industry but may be of any material which is rigid at normal temperature or other rubber-like flexible material. The third rubber element 301 provides a cushion between the third rotatable member 300 and the second rotatable member 200 and minimizing damage due to relative movement therebetween. The third rubber element 301 may be applied either as a separate rubber sleeve assembled over the outer periphery of the third rotatable member 300 or may be molded on or bonded to the third rotatable member 300 by steel pressing in a single operation.

The rotatable disk 400 is preferably mounted to the third rotatable member 300. The rotatable disk 400 is preferably driven to move correspondingly about the said rotating axis by the third rotatable member 300 thereof. Preferably, the rotatable disk 400 is mounted to and is supported by the chassis frame 600 thereof. It is preferred that the rotatable disk 400 is deployed in a side-by-side manner with the third rotatable member 300 thereof. The rotatable disk 400 includes, but is not limited to, a sprocket. The rotatable disk 400 comprises an axle that extends through a center hole in the third rotatable member 300 and the rotatable disk 400.

The rotatable disk 400 is preferably connected to the rotatable unit 501 of the electromechanical energy converter 500 thereof. According to one exemplary embodiment of the present invention, the rotatable disk 400 is connected to the rotatable unit 501 by a chain or belt. The chain or belt preferably extends around the rotatable disk 501 and the said rotatable disk 400 to drive the rotatable unit 501 thereof. According to another exemplary embodiment of the present invention, the rotatable disk 400 is in contact with the rotatable unit 501 of the electromechanical energy converter 500 thereof directly to drive the rotatable unit 501 thereof.

The electromechanical energy converter 500 is configured to generate electrical energy by way of rotation of its rotatable unit 501 that is coupled to the rotatable disk 400 thereof. It is preferred that the electromechanical energy converter 500 is mounted to and is supported by the chassis frame 600 thereof. The electrical energy generated thereof is delivered to a device required power, whether the device requires the power to operate or to charge a battery. An example of device that requires the power, i.e. the electrical energy, is an electric motor that can be configured to drive wheels attached thereto. The electric motor may be a 250 W 24V DC electric motor (2800 rpm).

It is preferred that the second rotatable member 200 has a diameter relatively smaller than that of the first rotatable member 100 and relatively larger than that of the third rotatable member 300.

The assembly of the present invention further comprises auxiliary wheels. The auxiliary wheels include auxiliary rear wheels and auxiliary front wheel. The chassis frame 600 may comprise a handle frame for maneuvering and adjusting direction of the chassis frame 600 that is propelled by the said auxiliary wheels thereof. The chassis frame 600 is generally employed for supporting the first rotatable member 100, the second rotatable member 200, the third rotatable member 300, the rotatable disk 400 and the electromechanical energy converter 500.

In accordance with one exemplary embodiment of the present invention, the first rotatable member 100 has the largest diameter which is about 213 cm or 7 feet in circumference. The larger the first rotatable member 100, the more mechanical power will be converted to the electrical energy at the electromechanical energy converter 500. The second rotatable member 200 is about 100 cm in circumference and it is smaller than the first rotatable member 100. The third rotatable member 300 is about 40 cm in circumference and it is smaller than the second rotatable member 200. The rotatable disk 400 is about 70 cm in circumference and it is bigger than the third rotatable member 300. The rotatable unit 501 which is another rotatable member is about 25 cm in circumference and it is smaller than the third rotatable member 300. Finally, the wheel attached to the electric motor is about 60 cm in circumference and it is bigger than the rotatable unit 501.

In use, for instance, when the first rotatable member 100 moves 10 times (i.e. 10 complete revolutions), the rotatable unit 501 of the electromechanical energy converter 500 moves 100 times (i.e. 100 complete revolutions). In other words, one complete revolution of the first rotatable member 100 translates into 10 complete revolutions of the rotatable unit 501. Similarly, when the first rotatable member 100 moves 100 times, the rotatable unit 501 moves 1000 times. So, when the rotatable unit 501 moves 100 times or 1,000 times or 10,000 times, the electromechanical energy converter 500 converts mechanical power to electrical energy. The electrical energy generated thereof runs a 250 W 24V DC electric motor (2800 rpm) which is proportional to the movement of first rotatable member 100.

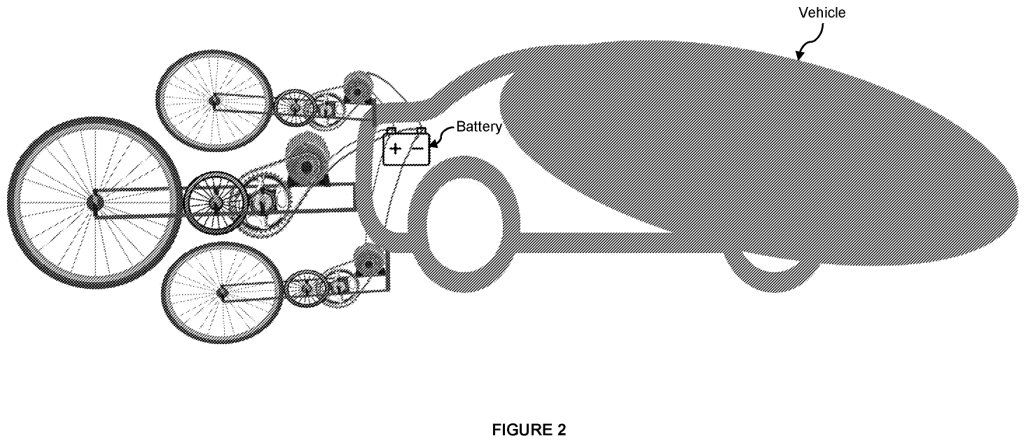

The present invention can be used in a variety of applications including vehicles. FIG. 2 illustrates an example of the assembly of the present invention (illustrated in FIG. 1) used with a vehicle, for example, car. According to the arrangement in FIG. 2, there are three assemblies of the present invention employed for use with the car. The electrical energy generated by these assemblies is channeled to and stored in a battery. The power stored thereof may be used for various components resided in the said car.

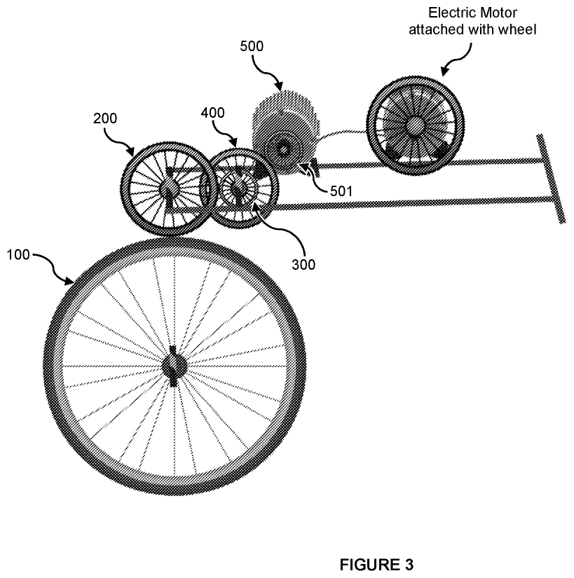

In accordance with one alternative embodiment of the present invention, there is provided an assembly for power generation as shown in FIG. 3 of the accompanying drawings. The first rotatable member 100 is configured to drive the second rotatable member 200. The third rotatable member 300 is driven to move by the second rotatable member 200. The rotatable disk or member 400 is mounted to the third rotatable member 300 and is driven to move correspondingly about the rotating axis by the third rotatable member 300. The rotatable disk or member 400 is configured to drive the rotatable unit 501 of the electromechanical energy converter 500.

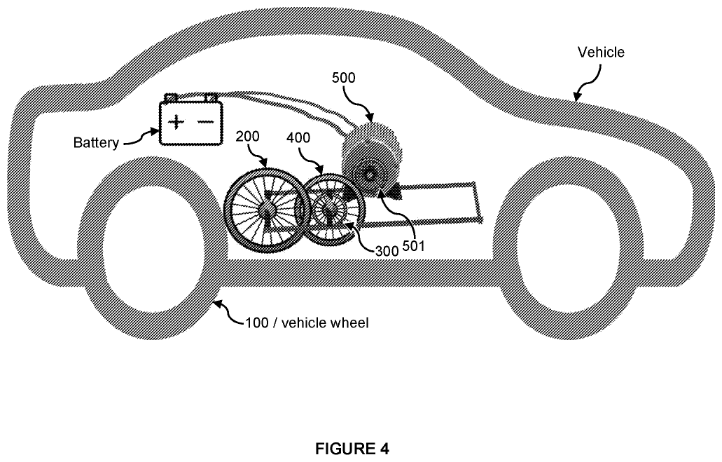

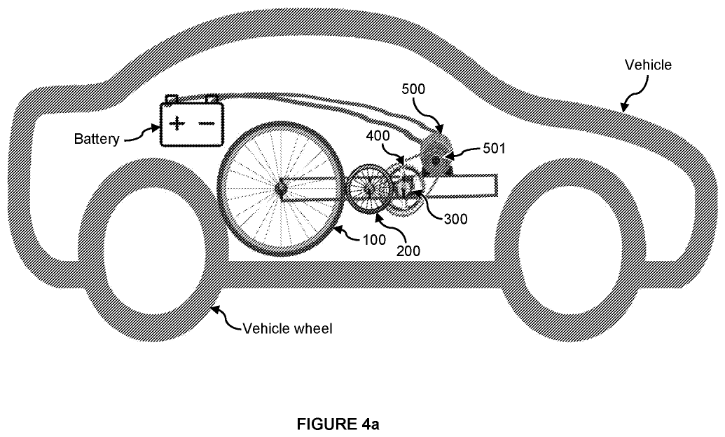

In accordance with one alternative embodiment of the present invention, with reference to FIG. 4, there is provided an arrangement of the assembly of FIG. 3 for use within a vehicle. In this regard, the first rotatable member 100 which is connected to the second rotatable member 200 may be replaced by a vehicle wheel. The electrical energy generated by this assembly is channeled to and stored in a battery. The power stored thereof may be used for various components resided in the said car. FIG. 4a, on the other hand, illustrates an arrangement of the assembly of FIG. 1 for use within a vehicle.

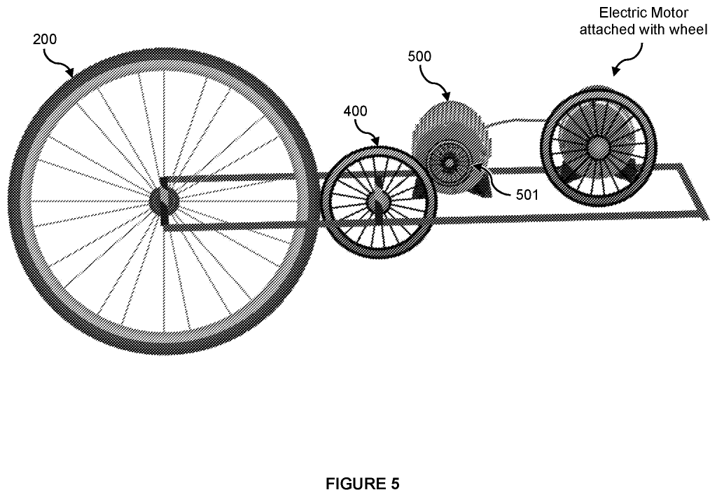

In accordance with one alternative embodiment of the present invention, with reference to FIG. 5, there is provided an assembly for power generation. The third rotatable member 300 is configured to drive the rotatable disk or wheel 400 which is directly connected to the rotatable unit 501 of the electromechanical energy converter 500.

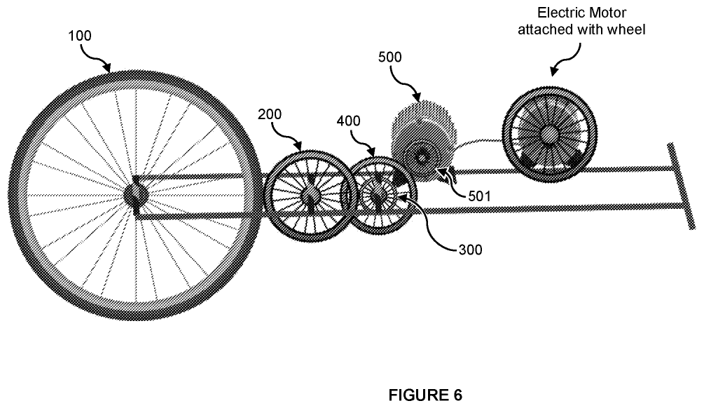

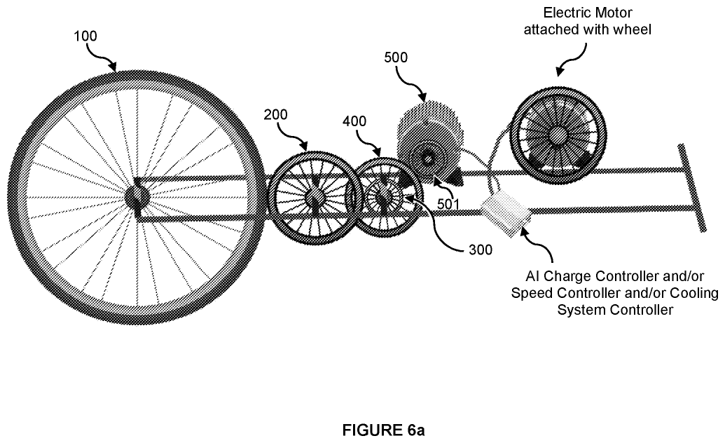

In accordance with one alternative embodiment of the present invention, with reference to FIG. 6, there is provided an assembly for power generation which is similar to that of FIG. 3 but with the first rotatable member 100 having a slightly different arrangement. The first rotatable member 100 is preferably linearly aligned with respect to the second rotatable member 200, and the third rotatable member 300 mounted to the rotatable disk or wheel 400. The rotatable disk or member 400 is configured to drive the rotatable unit 501 of the electromechanical energy converter 500. The electric motor may be equipped with a cooling system for cooling down the said electric motor. FIG. 6a illustrates the assembly of FIG. 6 that is deployed with an artificial intelligence (AI) charge controller, speed controller, cooling system controller, charge regulator, speed regulator, cooling system regulator or battery regulator. The charge controller preferably limits the rate at which electric current is drawn from the electromechanical energy converter 500. The charge controller and/or speed controller and/or cooling system controller may include a microcontroller. It can prevent overcharging and may protect the electric motor connected thereto against overvoltage, which can reduce its performance or lifespan, and may pose a safety risk. It is preferred that the charge controller and/or speed controller and/or cooling system controller is equipped with artificial intelligence (AI) algorithms. The AI algorithms includes, but are not limited to, fuzzy logic and artificial neural network. The AI algorithms can be used, for instance, to enhance charge controller performance by way of optimization of parameters of the charge controller and/or speed controller and/or cooling system controller.

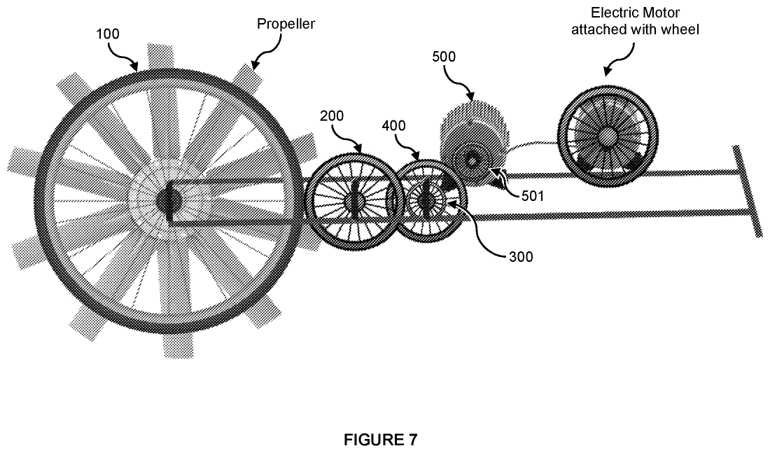

With reference to FIG. 7, there is provided an arrangement of the assembly of FIG. 6 with incorporation of a propeller assembly according to one alternative embodiment of the present invention. The propeller assembly is deployed on a side-by-side manner in respect of the first rotatable member 100 and is rotatable about the same axis of the first rotatable member 100.

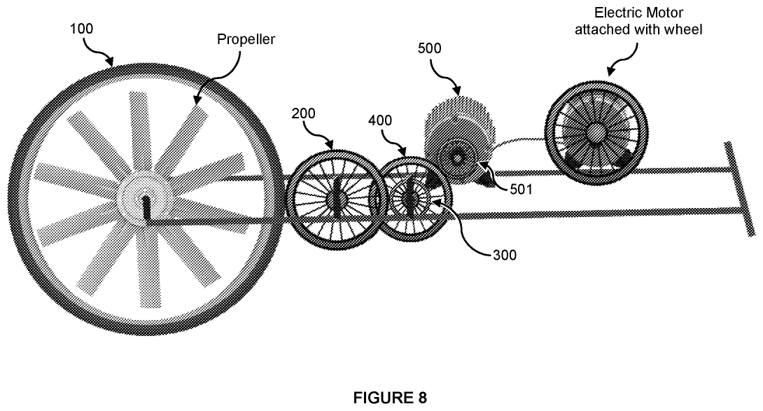

With reference to FIG. 8, there is provided an arrangement of the assembly of FIG. 6 with incorporation of a propeller assembly according to one alternative embodiment of the present invention. The propeller assembly is deployed within the first rotatable member 100 and is rotatable about the same axis of the first rotatable member 100.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. An assembly for power generation, comprising a series of rotatable members, characterized in that, the series of rotatable members comprising:
a first rotatable member (100);
a second rotatable member (200) driven to move by the first rotatable member (100) at which the second rotatable member (200) is in contact with;
a third rotatable member (300) driven to move about a rotating axis by the second rotatable member (200) thereof;
a rotatable disk (400) mounted to the third rotatable member (300) driven to move correspondingly about the said rotating axis by the third rotatable member (300) thereof; and
an electromechanical energy converter (500) having a rotatable unit (501) coupled to the rotatable disk (400) configured for generating electrical energy.

2. The assembly according to claim 1, wherein the rotatable disk (400) includes a sprocket deployed in a side-by-side manner with the third rotatable member (300) thereof.

3. The assembly according to claim 1, wherein the rotatable disk (400) is connected to the rotatable unit (501) of the electromechanical energy converter (500) by a chain or belt that extends around the rotatable disk (400) and the said rotatable unit (501) so as to drive the rotatably unit (501) thereof.

4. The assembly according to claim 1, wherein the rotatable disk (400) is in contact with the rotatable unit (501) of the electromechanical energy converter (500) directly to drive the rotatable unit (501) thereof.

5. The assembly according to claim 4, wherein the first rotatable member (100) comprises a first rubber element (101) mounted to the first rotatable member (100) thereof.

6. The assembly according to claim 1, wherein the second rotatable member (200) is in contact with the third rotatable member (300) to drive the third rotatable member (300) thereof.

7. The assembly according to claim 6, wherein the second rotatable member (200) comprises a second rubber element (201) mounted to the second rotatable member (200) thereof.

8. The assembly according to claim 6, wherein the third rotatable member (300) comprises a third rubber element (301) mounted to the third rotatable member (300) thereof.

9. The assembly according to claim 1, wherein the second rotatable member (200) has a diameter relatively smaller than that of the first rotatable member (100) and relatively larger than that of the third rotatable member (300).

10. The assembly according to claim 1, wherein the first rotatable member (100) is configured to initiate rotation of the second rotatable member (200) by way of rotating itself.

11. The assembly according to claim 1 comprises a chassis frame (600) for supporting the first rotatable member (100), the second rotatable member (200), the third rotatable member (300), the rotatable disk (400) and the electromechanical energy converter (500).

12. A method of power generation, characterized in that, the method comprising the steps of:
initiating rotation of a second rotatable member (200) by way of rotating a first rotatable member (100) which is in contact with the second rotatable member (200) thereof;
driving, by the second rotatable member (200), rotation of a third rotatable member (300) to move about a rotating axis;
driving, by the third rotatable member (300), rotation of a rotatable disk (400) mounted to the third rotatable member (300) to move correspondingly about the said rotating axis; and
driving, by the rotatable disk (400), rotation of a rotatable unit (501) of an electromechanical energy converter (500) for generating electrical energy.
